(19) United States
(12) Patent Application Publication
(10) Pub. No.: US 2012/0047241 A1
(43) Pub. Date: Feb. 23, 2012

(54) Apparatus, system, and method of managing an image forming device, and medium storing control program

(75) Inventor: Hiroshi Hozumi, Kanagawa (JP)

(73) Assignee: Ricoh Company, Ltd., Tokyo (JP)

(21) Appl. No.: 13/137,438

(22) Filed: Aug. 16, 2011

(30) Foreign Application Priority Data
Aug. 19, 2010 (JP) 2010-184354

(51) Int. Cl. G06F 15/173

(52) U.S. Cl. 709/223

(57) ABSTRACT

An apparatus, system, and method of managing an image forming device on a network, and a control program for managing the image forming device are disclosed. The management apparatus communicates with a plurality of network devices on the network by specifying a multicast address to generate a network device list, which lists address information of each of the plurality of network devices. The management apparatus communicates with one or more network devices each having the address information listed in the network device list to request each one of the one or more network devices for identification information of an image forming device. The management apparatus determines that at least one network device from which the identification information of the image forming device is successfully received as an image forming device to be managed by the management apparatus.

### CROSS-REFERENCE TO RELATED APPLICATIONS

This patent application is based on and claims priority under 35 U.S.C. §119 to Japanese Patent Application No. 2010-184354, filed on Aug. 19, 2010, in the Japan Patent Office, the entire disclosure of which is hereby incorporated herein by reference.

### FIELD OF THE INVENTION

The present invention generally relates to an apparatus, system, and method of managing an image forming device on a network such as a facsimile, printer, copier, or multifunctional product, and a recording medium storing a control program for causing the apparatus or system to manage the image forming device on the network.

### BACKGROUND

The management apparatuses manage a plurality of image forming devices on a network, which are specified through searching one or more image forming devices that are located within a specific network. Japanese Patent Application Publication No. 2008-234180 discloses a management apparatus, which specifies one or more image forming devices to be managed based on information obtained from a network segment specified using a multicast group address. While this technique of specifying the image forming devices by multicast may be applicable to the IPv4 network environment where the range of addresses for search is quite limited, this technique may not be applicable to the IPv6 network environment where the range of addresses for search is broad.

### SUMMARY

In view of the above, an object of the present invention is to provide a technique of specifying one or more image forming devices to be managed with improved efficiency even in the IPv6 network environment, or in the network environment where both the IPv6 network and the IPv4 network are present.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a functional structure of a device management apparatus, according to an example embodiment of the present invention;

FIG. 2 is an illustration of a configuration of a network system in which the device management apparatus of FIG. 1 is provided, according to an example embodiment of the present invention:

FIG. 3 is a data sequence diagram illustrating operation of generating an image forming device list, performed by the device management apparatus of FIG. 1, according to an example embodiment of the present invention;

FIG. 4 is an illustration of an example data structure of a network device list, generated by the device management apparatus of FIG. 1;

FIG. 5 is an illustration of an example filtering rule, managed by the device management apparatus of FIG. 1;

FIG. 6 is an illustration of an example data structure of an image forming device list, generated by the device management apparatus of FIG. 1;

FIG. 7 is a data sequence diagram illustrating operation of generating an image forming device result, performed by the device management apparatus of FIG. 1, according to an example embodiment of the present invention;

FIG. 8 is an illustration of an example data structure of a network device list, generated by the device management apparatus of FIG. 1;

FIG. 9 is an illustration of an example data structure of an image forming device list, generated by the device management apparatus of FIG. 1;

FIG. 10 is a data sequence diagram illustrating operation of generating an image forming device result, performed by the device management apparatus of FIG. 1, according to an example embodiment of the present invention;

FIG. 11 is an illustration of an example data structure of a network device list, generated by the device management apparatus of FIG. 1;

FIG. 12 is an illustration of an example data structure of an image forming device list, generated by the device management apparatus of FIG. 1;

FIG. 13 is a data sequence diagram illustrating operation of generating an image forming device list, performed by the device management apparatus of FIG. 1, according to an example embodiment of the present invention;

FIG. 14 is an illustration of an example data structure of a network device list, generated by the device management apparatus of FIG. 1; and

FIG. 15 is an illustration of an example data structure of an image forming device list, generated by the device management apparatus of FIG. 1.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

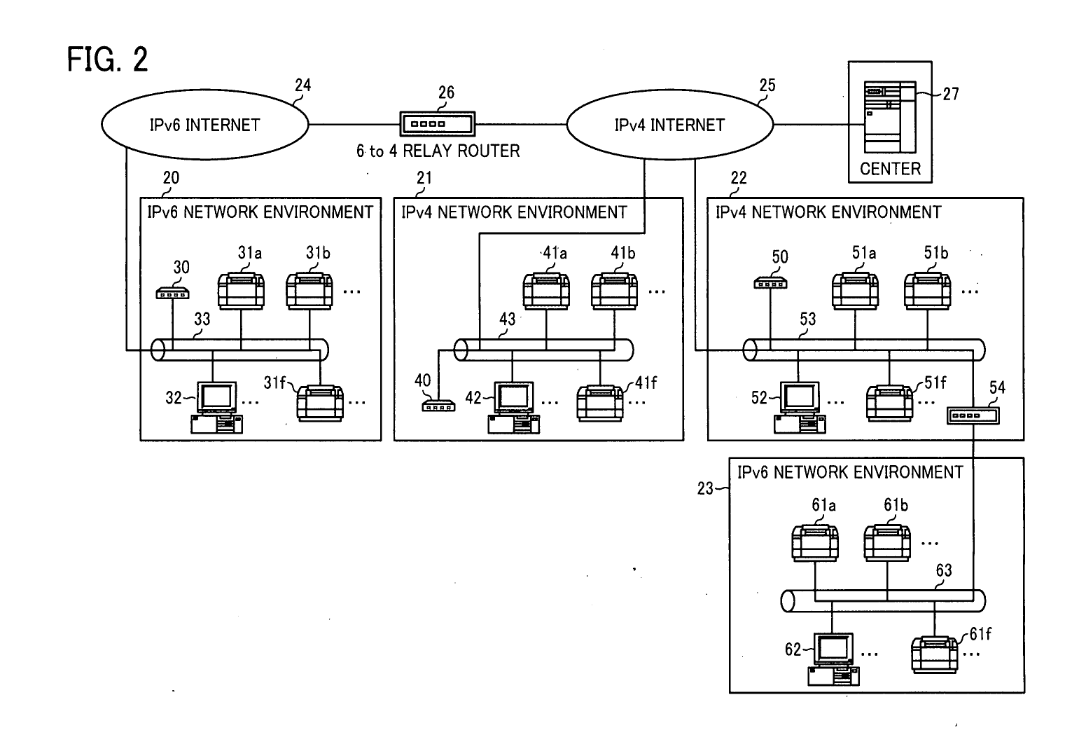

FIG. 2 illustrates a configuration of a network system according to an example embodiment of the present invention. As illustrated in FIG. 2, the network system of FIG. 2 includes a plurality of image forming devices such that it may be alternatively referred to as an image forming device management system. The network system of FIG. 2 includes networks 20 and 23 each of which operates in the IPv6 network environment, and networks 21 and 22 each of which operates in the IPv4 network environment. The network 20 is connected to the IPv6 Internet 24. The IPv6 Internet 24 and the IPv4 Internet 25 are connected via the 6to4 relay router 26. The IPv4 Internet 25 is connected to the network 21, the network 22, and a center apparatus 27. The network 22 is connected to the network 23 through the 6to4 router 54.

The network 20 includes a device management apparatus 30, a plurality of image forming devices such as a plurality of multifunctional products (MFP) 31a, 31b, . . . , 31f (collectively referred to as the MFP 31), and a plurality of information processing apparatuses such as a plurality of personal computers (PC) 32 (collectively referred to as the PC 32), which are connected through a local area network (LAN) 33. In this example, the LAN 33 includes the Ethernet. Through the LAN 33, any other apparatus such as a server apparatus may be connected. For the MFP 31 and the PC 32 that are connected through the LAN 33 on the network 20, an IPv6 multicast address may be designated such that the Internet control message protocol (ICMPv6) message can be transmitted to the devices on the network 20 each assigned with the IPv6 multicast address by specifying the IPv6 multicast address as a destination address. Any device on the network 20 is communicable with any other device on the outside network through the IPv6 Internet 24.

The network 21 includes a device management apparatus 40, a plurality of image forming devices such as a plurality of MFPs 41a, 41b, . . . , 41f (collectively referred to as the MFP 41), and a plurality of information processing apparatuses such as PCs 42 (collectively referred to as the PC 42), through the LAN 43. Although not shown, the network 21 may additionally include any other apparatus such as a server apparatus, which is connected to the LAN 43. For the MFP 41 and the PC 42 that are connected to the LAN 43 on the network 21, an IPv4 multicast address may be designated such that the ICMPv4 message can be transmitted to the devices on the network 21 each assigned with the IPv4 multicast address by specifying the IPv4 multicast address as a destination address. Any device on the network 21 is communicable with any other device on the outside network through the IPv4 Internet 25.

The network 22 includes a device management apparatus 50, a plurality of image forming devices such as a plurality of MFPs 51a, 51b, . . . , 51f (collectively referred to as the MFP 51), and a plurality of information processing apparatuses such as PCs 52 (collectively referred to as the PC 52), through the LAN 53. The network 22 is connected to the network 23 through the 6to4 router 54. The network 22 may further include any other apparatus such as a server apparatus, which is connected to the LAN 53. For the MFP 51 and the PC 52 that are connected through the LAN 53 on the network 22, an IPv4 multicast address may be designated such that the ICMPv4 message can be transmitted to the devices on the network 22 each assigned with the IPv4 multicast address by specifying the IPv4 multicast address as a destination address. However, in this example, the use of address resolution protocol (arp) is prohibited on the network 22. The network 22 is connected to the IPv4 Internet 25 such that the MFP 51 and the PC 52 can be communicated with any other device on the outside network through the IPv4 Internet 25.

The network 23 includes a plurality of image forming devices such as a plurality of MFPs 61a, 61b, . . . , 61f (collectively referred to as the MFP 61), and a plurality of information processing apparatuses such as PCs 62 (collectively referred to as the PC 62), through the LAN 63. The network 23 may additionally include any other apparatus such as a server apparatus, which is connected to the LAN 63. For the MFP 61 and the PC 62 that are connected to the LAN 63 on the network 23, an IPv6 multicast address may be designated such that the ICMPv6 message can be transmitted to the devices on the network 23 each assigned with the IPv6 multicast address by specifying the IPv6 multicast address as a destination address. However, in this example, the management apparatus 50 provided on the network 22 manages the MFP 61 and the PC 62 on the network 23, and the use of ICMPv6 is prohibited on the network 23.

In the above-described example, the MFP is connected through the LAN. In addition or alternative to the MFP, any other image forming device such as facsimile, printer, or copier may be connected through the LAN. Further, any one of the device management apparatuses 30, 40, and 50 may be replaced by the image forming apparatus provided with the function of managing a device on the network including an image forming device on the network.

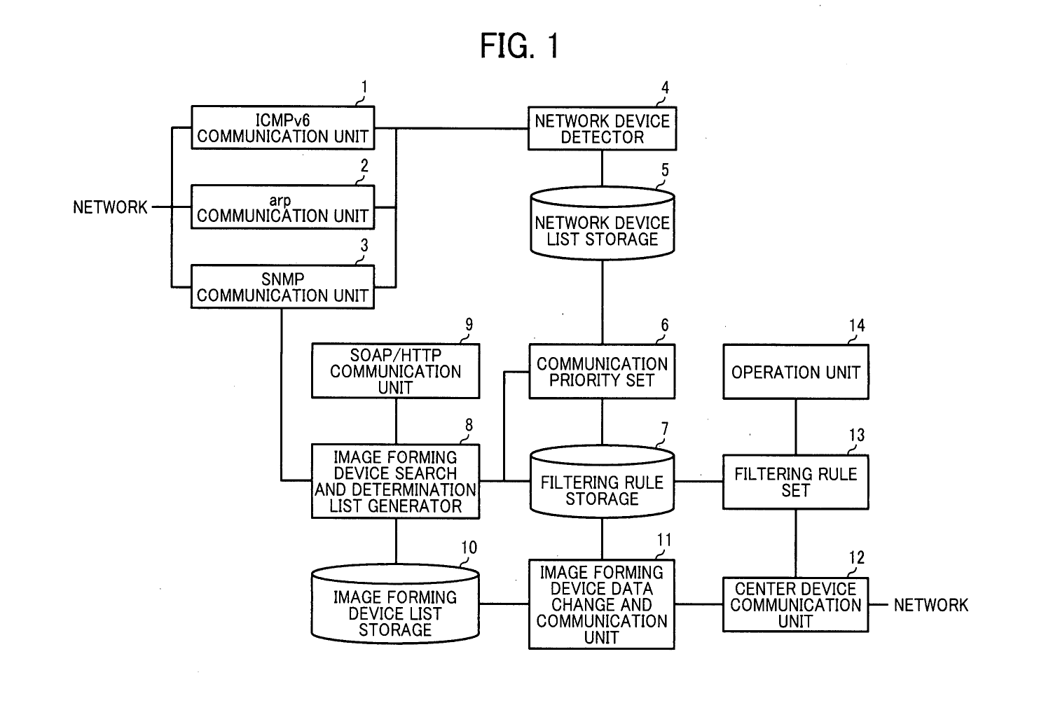

FIG. 1 illustrates a functional structure of each one of the device management apparatuses 30, 40, and 50, (collectively referred to as a management apparatus) provided on the network system of FIG. 2.

The management apparatus includes a processor and a storage device such as a memory. The processor may be implemented by a microcomputer such as a central processing unit (CPU). The storage device may include a read only memory (ROM) and a random access memory (RAM). In addition to the processor and the storage device, the management apparatus includes a communication device that allows the management apparatus to communicate with any other device on the network, such as a network interface, facsimile interface, etc. The management apparatus may further include an input/output device such as a display, keyboard, mouse, which allows the management apparatus to interact with the user.

When the CPU loads a control program stored in the ROM onto the RAM that functions as a work area of the CPU, the management apparatus is caused to have various functional modules illustrated in FIG. 1. More specifically, in this example illustrated in FIG. 1, the management apparatus includes an ICMPv6 communication unit 1, an arp communication unit 2, a simple network management protocol (SNMP) communication unit 3, a network device detector 4, a communication priority set 6, an image forming device search and determination list generator 8, a simple object access protocol (SOAP)/hypertext transfer protocol (HTTP) communication unit 9, an image forming device data change and communication unit 11, a center device communication unit 12, and a filtering rule set 13, which may be implemented by the CPU and the communication device. The management apparatus further includes a network device list storage 5, a filtering rule storage 7, and an image forming device list storage 10, each of which may be implemented by the storage device. The management apparatus of FIG. 1 further includes an operation unit 14, which may be implemented by the input/output device.

The ICMPv6 communication unit 1 controls ICMPv6 communication with the devices on the network. As illustrated in FIG. 2, the network includes the LAN 33, 43, 53, and 63, the IPv6 Internet 24 and the IPv4 Internet 25. The arp communication unit 2 controls arp communication with the devices on the network. The SNMP communication unit 3 controls SNMP communication with the devices on the network.

The network device detector 4 controls the ICMPv6 communication unit 1, the arp communication unit 2, and the SNMP communication unit 3. The network device detector 4 collects address information of each node, which is the address information of one or more devices provided on the network, at a predetermined time. For simplicity, any device provided on the network, which includes an image forming device, may be referred to as a network device. Based on the collected address information, the network device detector 4 generates a network device list, which includes address information indicating the address of each of the network devices that are collected from the network.

The network device list storage 5 stores the network device list, which lists address information of one or more network devices obtained by the network device detector 4.

The communication priority set 6 refers to a filtering rule that is stored in the filtering rule storage 7 to determine whether any network device having its address information listed on the network device list is a device that is subjected for search. More specifically, in this example, information regarding a media access control (MAC) address prefix is stored as the filtering rule. The communication priority set 6 further determines the priority in communicating each device subjected for search, using the filtering rule. The image forming device determination list may be generated, which stores one or more devices subjected for search, after the filtering rule is applied to the network device list.

The image forming device search and determination list generator 8 communicates with each network device that is listed in the image forming device determination list to request each device for identification information of an image forming device on the network. Based the identification information of the MFP that is obtained from each network device that is communicated, the image forming device search and determination list generator 8 generates an image forming device list, which lists address information of one or more MFPs on the network that are subjected for management by the management apparatus. For example, the image forming device search and determination list generator 8 determines that the network device is an image forming device, or MFP, to be managed, when the management apparatus receives the identification information indicating the image forming device in response to a request sent by the management apparatus.

The SOAP/HTTP communication unit 9 controls SOAP or HTTP communication with the network devices on the network.

The image forming device list storage 10 stores an image forming device list that lists one or more MFPs subjected for management by the management apparatus. The image forming device list storage 10 may additionally store an image forming device determination list, which lists one or more devices to be determined by the management apparatus whether each device is an image forming device subjected for management.

The image forming device data change and communication unit 11 registers the address information of one or more MFPs to be managed, to the image forming device list storage 10 or to the center apparatus 27. In one example, the image forming device data change and communication unit 11 notifies the center apparatus 27 of information regarding one or more image forming devices, or MFP in this example, which are determined to be subjected for management.

The center device communication unit 12 controls communication with the center apparatus 27 through the network.

The filtering rule set 13 stores the filtering rule, such as the MAC address prefix, in the filtering rule storage 7.

The operation unit 14 inputs a user instruction with respect to the management apparatus, which is received through the web interface. The operation unit 14 further displays various information for display to the user.

In this example, the ICMPv6 communication unit 1, the arp communication unit 2, the SNMP communication unit 3, and the network device detector 4 collectively perform the address information collection function of collecting address information of the network devices through communicating with the network devices on the network by multicast.

The network device detector 4 and the network device list storage 5 collectively perform the device list generating function of generating a list of the address information of the network devices, which are collected by the address information collection function.

The SOAP/HTTP communication unit 9, the SNMP communication unit 3, and the image forming device search and determination list generator 8 collectively perform the identification information obtaining function of obtaining the identification information of the image forming device through communicating the network devices each having its address information listed in the list generated by the device list generating function.

The image forming device search and determination list generator 8 performs the image forming device determination function of determining the network device having the identification information of the image forming device that is obtained by the identification information obtaining function, as the image forming device. The image forming device search and determination list generator 8 performs the image forming device list generating function of generating a list of the address information of the network device that is determined to be the image forming device.

The filtering rule storage 7 performs the rule information storage function of storing rule information, which is used to determine whether any one of the devices each having its address information listed in the list generated by the device list generating function is subjected for further communication. The rule information stored in the filtering rule storage 7 is used to further determine a priority order in communicating each of the devices subjected for further communication.

The communication priority set 6 performs the communication determination function, which includes: referring to the rule information stored in the rule information storage function to determine whether any one of the devices each having its address information listed in the list generated by the device list generating function is subjected for further communication. The communication priority set 6 further determines the priority order in communicating each of the devices subjected for further communication.

The image forming device search and determination list generator 8 communicates with each of the devices subjected for further communication, which are determined by the communication priority set 6, in the priority order determined by the communication priority set 6, to obtain the identification information of the image forming device.

The ICMPv6 communication unit 1 and the network device detector 4 collectively perform the address information collection function, which includes: obtaining the IPv6 multicast address designated to the management apparatus; transmitting the ICMPv6 message to each one of the network devices on the network by specifying the IPv6 multicast address designated to the management apparatus. Based on the response from the network device in response to the ICMPv6 message, the ICMPv6 communication unit 1 and the network device detector 4 collect the address information of the network device, which includes the IPv6 address information of the device and the MAC address information of the device.

The ICMPv6 communication unit 1 and the network device detector 4 collectively perform the address information collection function, which includes: obtaining the IPv6 multicast address designated to the network to which the management apparatus is connected; transmitting the message to each of the plurality of devices each having the IPv6 multicast address by specifying the designated IPv6 multicast address; and collecting the address information of each of the devices from the response received from each device, the address information including the IPv6 address information and the MAC address information of each device.

The arp communication unit 2 and the network device detector 4 collectively perform the address information collection function, which includes: obtaining the IPv4 multicast address designated to the management apparatus; transmitting the arp message to each of the plurality of devices each having the IPv4 multicast address by specifying the designated IPv4 multicast address as a destination address; and collecting the address information of each of the devices from the response received from each device, the address information including the IPv4 address information and the MAC address information of each device.

The arp communication unit 2 and the network device detector 4 collectively perform the address information collection function, which includes: obtaining the IPv4 multicast address designated to the network to which the management apparatus is connected; transmitting the arp message to each of the plurality of devices each having the IPv4 multicast address by specifying the designated IPv4 multicast address as a destination address; and collecting the address information of each of the devices from the response received from each device, the address information including the IPv4 address information and the MAC address information of each device.

The image forming device information change and communication unit 11 and the center device communication unit 12 collectively perform the registering function, which includes: when the image forming device subjected for management is selected from the image forming device list generated by the image forming device list function, registering the address information of the selected image forming device to the management apparatus and/or the center apparatus on the network.

The SNMP communication unit 3, the image forming device search and determination result generator 8, the SOAP/HTTP communication unit 9, the image forming device list storage 10, the image forming device information change and communication unit 11, and the center device communication unit 12, collectively perform the following updating function. When the management apparatus detects that communication with the image forming device registered by the registering function is interrupted for a predetermined time period, the updating function checks a location of the image forming device being interrupted on the network using the MAC address of the image forming device. Based on the checked location, the address information of the image forming device that is registered to the management apparatus and/or the center apparatus is updated.

The image forming device change and communication unit 11 and the center device communication unit 12 collectively perform the communicating function, which notifies the center apparatus on the network of the address information of the device that is determined to be the image forming device by the image forming device determining function.

The image forming device information change and communication unit 11 and the center device communication unit 12 collectively perform the setting function, which sets various information to be used by the management apparatus for multicast communication with a plurality of devices on the network based on the information received from the center apparatus on the network.

The image forming device information change and communication unit 11 and the center device communication unit 12 collectively perform the time setting function, which causes the management apparatus to set a time at which the image forming device list generating function generates the list based on the information received from the center apparatus on the network.

The center device communication unit 12 and the filtering rule set 13 collectively perform the function of causing the rule information storage function to store the rule information received from the center apparatus on the network.

The SNMP communication unit 3 and the image forming device search and determination list generator 8 collectively perform the address information collection function, in the network environment where the use of ICMPv6 is prohibited. The address information collection function transmits the SNMP message to each of the plurality of devices designated with the IPv6 multicast address by specifying the IPv6 multicast address as a destination address, and collects the address information of each device from the response received from each device, the address information including the IPv6 address information and the MAC address information of each device.

The SNMP communication unit 3 and the image forming device search and determination list generator 8 collectively perform the address information collection function in the network environment where the use of arp is prohibited. The address information collection function transmits the SNMP message to each one of the plurality of devices having the IPv4 multicast address by specifying the IPv4 multicast address as a destination address, and collects the address information of each device from the response received from each device, the address information including the IPv4 address information and the MAC address information of each device.

The image forming device search and determination list generator 8 performs the identification information obtaining function, which obtains the identification information of the image forming device by SOAP communication, HTTP communication, or SNMP communication through the network.

The MFP 31a, 31b, 31c, . . . 31f, 41a, 41b, 41c, . . . 41f, 51a, 51b, 51c, . . . 51f, and 61a, 61b, 61c, . . . 61f, which are collectively referred to as the MFP 31, 41, 51, and 61, are each provided with a controller device, a communication device, and an image forming device. The controller device is implemented by a microcomputer including a CPU provided with a memory such as ROM and RAM. The image forming device forms an image on a recording medium such as a recording sheet. The controller device performs the information transmit function, which transmits the address information and the identification information of the MFP in response to the request received from the management apparatus 30, 40, or 50.

The center apparatus 27 includes a controller device, which may be implemented by a microcomputer such as a CPU provided with a memory such as ROM and RAM. The controller device registers information regarding the MFP subjected for management, which is received from the management apparatus 30, 40, or 50. The controller device transmits various information including information used for communication with the management apparatus 30, 40, or 50 through the network, and timing information specifying the time at which the image forming device list (may be referred to as the MFP list) is generated. The controller device registers the image forming device list, which lists the MFP subjected for management by the management apparatus 30, 40, or 50, in the storage device. The controller device updates the image forming device list according to information received from the management apparatus 30, 40, or 50. The controller device receives notification regarding the MFP that is found on the network from the management apparatus 30, 40, or 50. The controller device transmits the MAC address prefix, which is used for filtering with respect to the management apparatus 30, 40, or 50.

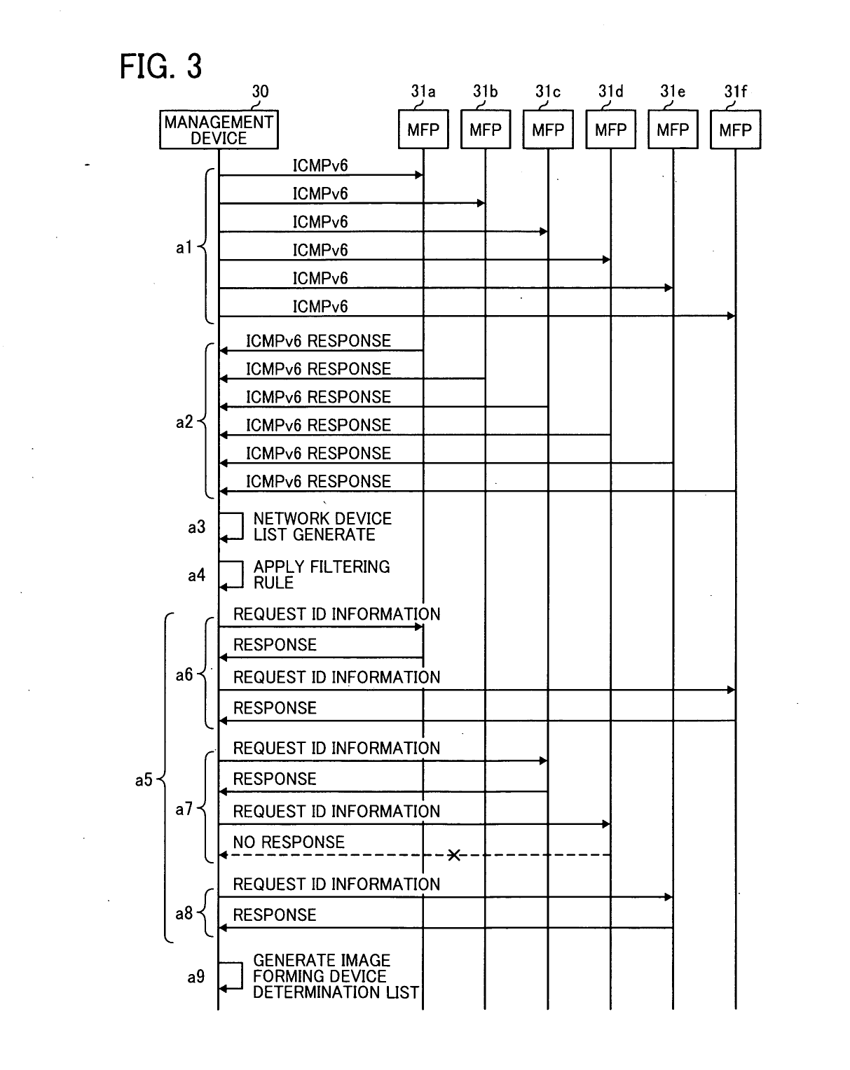

Referring now to FIGS. 1 to 6, operation of generating an image forming device list, performed by the management apparatus 30 in the network system of FIG. 2, is explained according to an example embodiment of the present invention. FIG. 3 illustrates a data sequence diagram illustrating operation of generating an image forming device list, performed by the management apparatus 30 with respect to the network devices on the network 20 illustrated in FIG. 2, according to an example embodiment of the present invention. The MFP 31c, 31d, and 31e of FIG. 3 are not shown in FIG. 2. This example illustrates the case in which the image forming device list is generated for the network devices in the IPv6 network environment.

At a1 and a2 of FIG. 3, the management apparatus 30 of FIG. 2 communicates with a plurality of devices on the network by multicast to collect the address information of each of the devices on the network.

In the process of collecting address information of each device on the network, the network apparatus 30 of FIG. 1 obtains the IPv6 multicast address designated to the management apparatus 30, which may be designated through the operation unit 14 of FIG. 1 or the center apparatus 27 of FIG. 2. The network apparatus 30 may alternatively obtain the IPv6 multicast address that is designated to the LAN 33 to which the management apparatus 30 is connected. The network device detector 4 causes the ICMPv6 communication unit 1 to transmit the ICMPv6 message to each one of the devices on the network 20 by specifying the designated IPv6 multicast address as a destination address. In this example, at a1 of FIG. 3, the ICMPv6 communication unit 1 transmits the ICMPv6 message to the MFPs 31a to 31f, respectively.

At a2 of FIG. 3, the network device detector 4 of the management apparatus 30 receives, through the ICMPv6 communication unit 1, the ICMPv6 response from the MFPs 31a to 31f, respectively. The ICMPv6 response includes the IPv6 address information and the MAC address information of the MFP 31. In this manner, address information for each one of the MFPs 31a to 31f on the network 20 is collected.

At a3 of FIG. 3, the management apparatus 30 generates a network device list, which lists the address information of each of the MFPs 31a to 31f that are collected at a2.

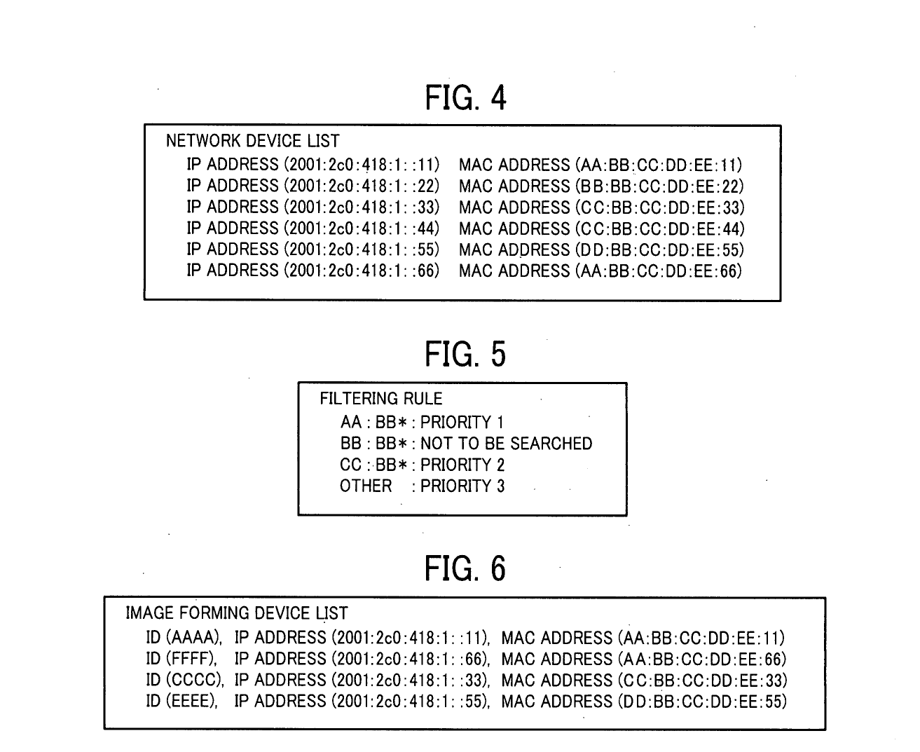

In this example, as illustrated in FIG. 4, the network device list includes the IP address “2001:2c0:418:1::11” and MAC address “AA:BB:CC:DD:EE:11” of the MFP 31a, the IP address “2001:2c0:418:1::22” and the MAC address “BB:BB:CC:DD:EE:22” of the MFP 31b, the IP address “2001:2c0:418:1::33” and the MAC address “CC:BB:CC:DD:EE:33” of the MFP 31c, the IP address “2001:2c0:418:1::44” and the MAC address “CC:BB:CC:DD:EE:44” of the MFP 31d, the IP address “2001:2c0:418:1::55” and the MAC address “DD:BB:CC:DD:EE:55” of the MFP 31e, and the IP address “2001:2c0:418:1::66” and the MAC address “AA:BB:CC:DD:EE:66” of the MFP 31f.

At a4 of FIG. 3, the management apparatus 30 determines whether any one of the devices listed in the network device list is a device to be communicated, based on the filtering rule stored in the filtering rule storage 7. When there is more than one device to be communicated, the management apparatus 30 further determines a priority order in communicating each device based on the filtering rule stored in the filtering rule storage 7. More specifically, in this example, the management apparatus 30 determines whether any one of the MFPs 31a to 31f listed in the network device list of FIG. 4 needs to be communicated, and determines a priority order in communicating the MFPs 31a to 31f.

Further, in this example, the filtering rule set 13 stores a filtering rule, which may be input through the operation unit 14 or received through the center device communication unit 12 from the center apparatus 27, in the filtering rule storage 7. The filtering rule set 13 may update the filtering rule stored in the filtering rule storage 7 according to an instruction received through the operation unit 14 or through the center device communication unit 12.

In this example, it is assumed that the filtering rule of FIG. 5 is stored in the filtering rule storage 7. The filtering rule of FIG. 5 specifies that any device having the MAC address “AA:BB*” is to be communicated first (“PRIORITY 1”), any device having the MAC address “BB:BB*” is not to be searched as it is not communicated (“NOT TO BE SEARCHED”), any device having the MAC address “CC:BB*” is to be communicated second (“PRIORITY 2”), and any device having the MAC address other than the above is to be communicated third (“PRIORITY 3”). The symbol “*” indicates any arbitrary character.

Based on the filtering rule stored in the filtering rule storage 7, the communication priority set 6 of the management apparatus 30 determines that the MFP 31a and the MFP 31f are to be communicated first, the MFP 31b to be not searched, the MFP 31c and MFP 31d to be communicated second, and the MFP 31e to be communicated third. This determination result is sent to the image forming device search and determination list generator 8. Based on this determination result, the image forming device search and determination list generator 8 may generate an image forming device determination list, which lists one or more devices to be communicated.

At a5 of FIG. 5, the image forming device search and determination list generator 8 requests each device that is determined to be communicated to send the identification information of an image forming device. More specifically, as illustrated below, the image forming device search and determination list generator 8 communicates with the MFP 31, by SOAP communication or HTTP communication through the SOAP/HTTP communication unit 9, or by SNMP communication by the SNMP communication unit 3, to obtain identification information of the MFP 31. Further, the image forming device search and determination list generator 8 communicates with the MFP 31 in the priority order determined at a4 based on the filtering rule.

At a6, the image forming device search and determination list generator 8 communicates with the MFP 31a and the MFP 31f, which are to be communicated first. The image forming device search and determination list generator 8 communicates with the MFP 31a to obtain identification information of the MFP 31a. For example, the “ID: AAAA” of the MFP 31a may be obtained. In a substantially similar manner, the image forming device search and determination list generator 8 communicates with the MFP 31f to obtain the identification information of the MFP 31f, such as the “ID: FFFF” of the MFP 31f.

At a7 of FIG. 3, the image forming device search and determination list generator 8 communicates with the MFP 31c and the MFP 31d, which are to be communicated second. The image forming device search and determination list generator 8 communicates with the MFP 31c to obtain identification information “ID: CCCC” of the MFP 31c. The image forming device search and determination list generator 8 communicates with the MFP 31d. However, in this case, it is assumed that there is no response from the MFP 31d such that no identification information is obtained for the MFP 31d.

At a8 of FIG. 3, the image forming device search and determination list generator 8 communicates with the MFP 31e, which is to be communicated third, to obtain identification information “ID:EEEE” of the MFP 31e. The MFP 31b is not communicated as it is not to be searched.

At a9 of FIG. 3, the image forming device search and determination list generator 8 determines that one or more devices from which the identification information of the image forming device are successfully obtained, as an image forming device to be managed by the management apparatus 30. For example, as illustrated in FIG. 6, the image forming device search and determination list generator 8 generates an image forming device list, which stores the identification information that is obtained from the MFP 31 at a5 in association with the address information of the MFP 31 at a2 for the MFP 31a, 31b, 31c, 31e, and 31f. The image forming device list is stored in the image forming device list storage 10.

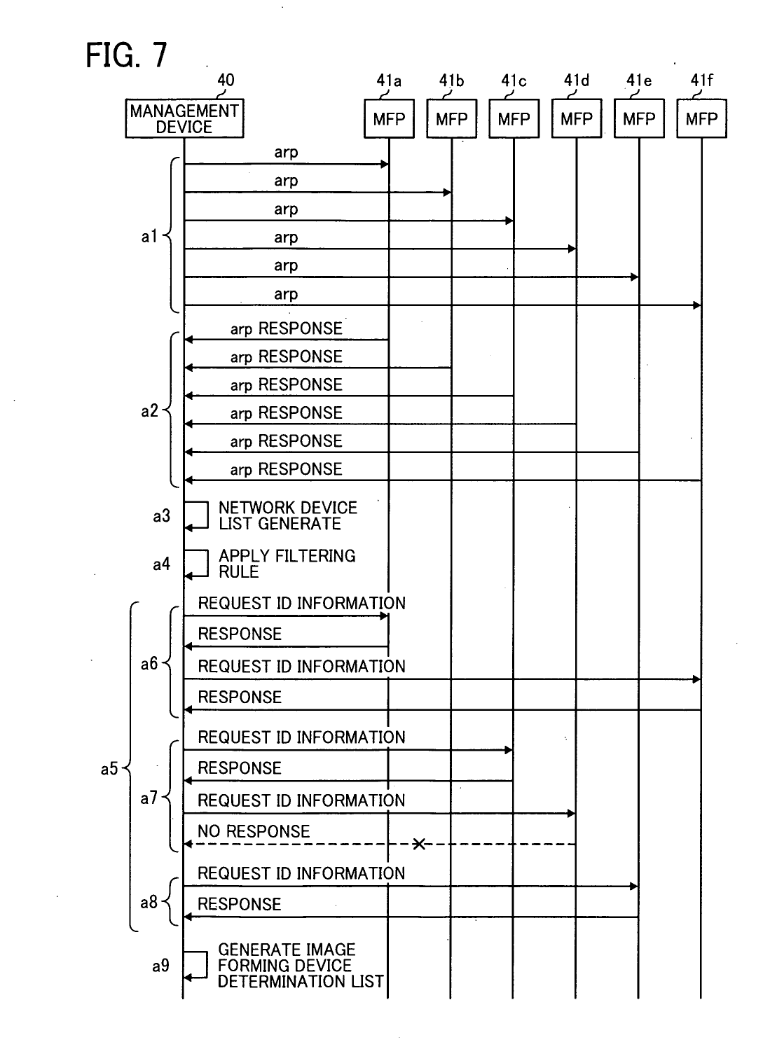

Referring now to FIGS. 1, 2, and 7 to 9, operation of generating an image forming device list, performed by the management apparatus 40 of the network system of FIG. 2, is explained according to an example embodiment of the present invention. FIG. 7 illustrates a data sequence diagram illustrating operation of generating an image forming device list of the devices on the network 21, performed by the management apparatus 40. The MFPs 41c, 41d, and 41e of FIG. 7 are not shown in FIG. 2. This example illustrates the case in which the image forming device list is generated for the network devices in the IPv4 network environment.

At a1 and a2 of FIG. 7, the management apparatus 40 of FIG. 2 communicates with a plurality of devices on the network by multicast to obtain address information of each of the devices on the network. For example, the IPv4 multicast address to be used for multicasting may be designated to the management apparatus 40 through the operation unit 14 of the management apparatus 40 or through the center apparatus 27. Alternatively, the LAN 43 to which the management apparatus 40 is connected may be previously designated with the IPv4 multicast address. The network device detector 4 causes the arp communication unit 2 to transmit the arp message to each one of the devices each having the designated IPv4 multicast address by specifying the designated IPv4 multicast address as a destination address. In this example, at a1 of FIG. 7, the network device detector 4 transmits the arp message to each one of the MFP 41a to 41f.

At a2 of FIG. 7, the network device detector 4 of the management apparatus 40 causes the arp communication unit 2 to receive an arp response from each one of the MFPs 41a to 41f to collect address information of each one of the MFPs 41a to 41f. The arp response includes the IPv4 address information and the MAC address information of each device.

At a3 of FIG. 7, the network list generator of the management apparatus 40 generates a network device list, which lists the address information of the MFPs 41a to 41f.

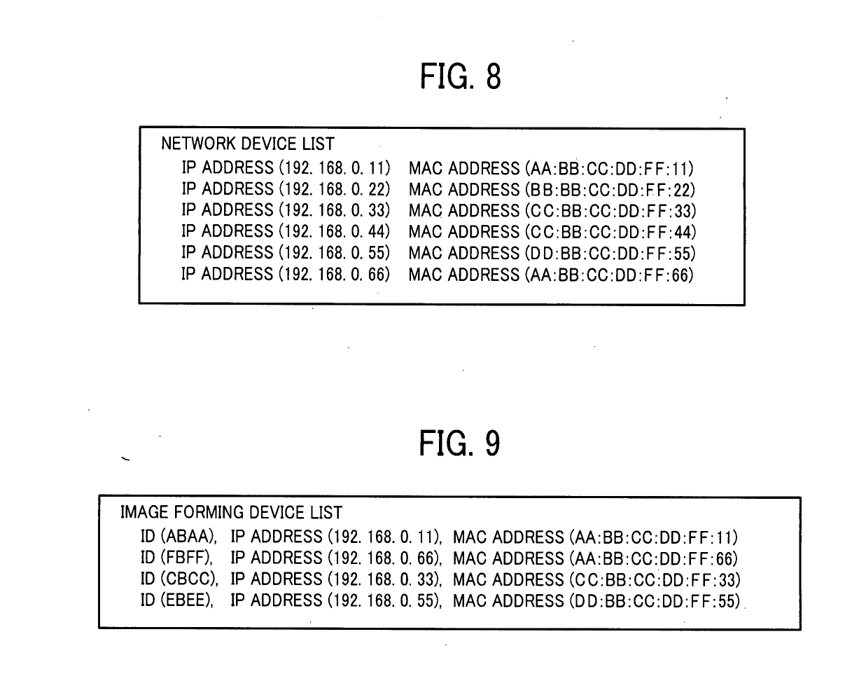

In this example, as illustrated in FIG. 8, the network device list includes the IP address “192.168.0.11” and the MAC address “AA:BB:CC:DD:FF:11” of the MFP 41a, the IP address “192.168.0.22” and the MAC address “BB:BB:CC:DD:FF:22” of the MFP 41b, the IP address “192.168.0.33” and the MAC address “CC:BB:CC:DD:FF:33” of the MFP 41c, the IP address “192.168.0.44” and the MAC address “CC:BB:CC:DD:FF:44” of the MFP 41d, the IP address “192.168.0.55” and the MAC address “DD:BB:CC:DD:FF:55” of the MFP 41e, and the IF address “192.168.0.66” and the MAC address “AA:BB:CC:DD:FF:66” of the MFP 41f.

At a4 of FIG. 7, the management apparatus 40 determines whether any one of the devices listed in the network device list is a device to be communicated, based on the filtering rule stored in the filtering rule storage 7. When there is more than one device to be communicated, the management apparatus 40 further determines a priority order in communicating each device based on the filtering rule stored in the filtering rule storage 7. More specifically, in this example, the management apparatus 40 determines whether any one of the MFPs 41a to 41f listed in the network device list of FIG. 8 needs to be communicated, and determines a priority order in communicating the MFPs 41a to 41f.

For example, assuming that the filtering rule of FIG. 5 is applied, the communication priority set 6 of the management apparatus 40 determines that the MFP 41a and the MFP 41f are to be communicated first, the MFP 41b to be not searched, the MFP 41c and the MFP 41d to be communicated second, and the MFP 41e to be communicated third. The determination result is sent to the image forming device search and determination list generator 8. Based on this determination result, the image forming device search and determination list generator 8 may generate an image forming device determination list, which lists one or more devices to be communicated.

At a5 of FIG. 7, the image forming device search and determination list generator 8 requests each device that is determined to be communicated to send the identification information of an image forming device. More specifically, as illustrated below, the image forming device search and determination list generator 8 communicates with the MFP 41, by SOAP communication or HTTP communication through the SOAP/HTTP communication unit 9, or by SNMP communication by the SNMP communication unit 3, to obtain identification information of the MFP 41. Further, the image forming device search and determination list generator 8 communicates with the MFP 41 in the priority order determined at a4 based on the filtering rule.

At a6, the image forming device search and determination list generator 8 communicates with the MFP 41a and the MFP 41f, which are to be communicated first. The image forming device search and determination list generator 8 communicates with the MFP 41a to obtain identification information of the MFP 41a. For example, the “ID: ABAA” of the MFP 41a may be obtained. In a substantially similar manner, the image forming device search and determination list generator 8 communicates with the MFP 41f to obtain the identification information of the MFP 41f, such as the “ID: FBFF” of the MFP 41f.

At a7 of FIG. 7, the image forming device search and determination list generator 8 communicates with the MFP 41c and the MFP 41d, which are to be communicated second. The image forming device search and determination list generator 8 communicates with the MFP 41c to obtain identification information “ID: CBCC” of the MFP 41c. The image forming device search and determination list generator 8 communicates with the MFP 41d. However, in this case, it is assumed that there is no response from the MFP 41d such that no identification information is obtained for the MFP 41d.

At a8 of FIG. 7, the image forming device search and determination list generator 8 communicates with the MFP 41e, which is to be communicated third, to obtain identification information “ID: EBEE” of the MFP 41e. The MFP 41b is not communicated as it is not to be searched.

At a9 of FIG. 7, the image forming device search and determination list generator 8 determines that one or more devices from which the identification information are successfully obtained, as an image forming device to be managed by the management apparatus 40. For example, as illustrated in FIG. 9, the image forming device search and determination list generator 8 generates an image forming device list, which stores the identification information that is obtained from the MFP 41 at a5 in association with the address information of the MFP 41 at a2 for the MFP 41a, 41b, 41c, 41e, and 41f. The image forming device list is stored in the image forming device list storage 10.

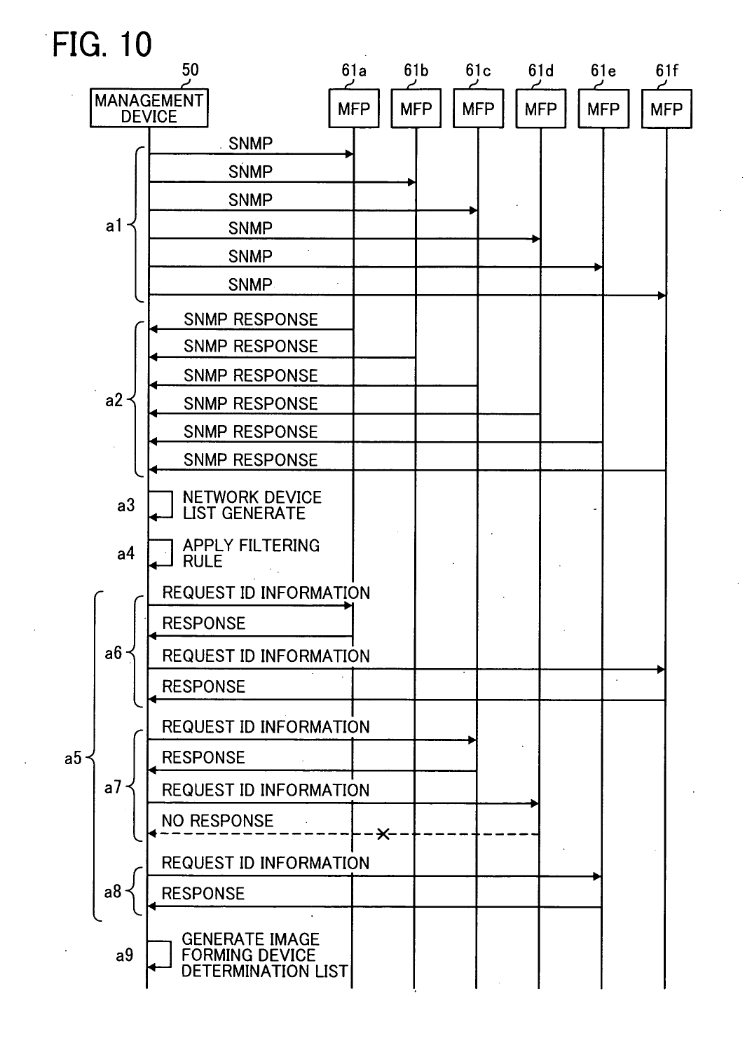

Referring now to FIGS. 1, 2, and 10 to 12, operation of generating an image forming device list, performed by the management apparatus 50 of the network system of FIG. 2, is explained according to an example embodiment of the present invention. FIG. 10 illustrates a data sequence diagram illustrating operation of generating an image forming device list of the devices on the network 23, performed by the management apparatus 50. The MFPs 61c, 61b, and 61e of FIG. 10 are not shown in FIG. 2. This example illustrates the case in which the image forming device list is generated for the network devices in the IPv6 environment where the use of ICMPv6 is prohibited.

At a1 and a2 of FIG. 10, the management apparatus 50 of FIG. 2 communicates with a plurality of devices on the network by multicast to obtain address information of each device on the network. For example, the IPv6 multicast address to be used for multicasting may be designated to the management apparatus 50 through the operation unit 14 of the management apparatus 50 or through the center apparatus 27. Alternatively, the LAN 63 to which the management apparatus 50 is connected, through the 6to4 router 54, may be previously designated with the IPv6 multicast address. The network device detector 4 causes the SNMP communication unit 3 to transmit the SNMP message to each one of the devices each having the designated IPv6 multicast address by specifying the designated IPv6 multicast address as a destination address. In this example, at a1 of FIG. 10, the network device detector 4 causes the SNMP communication unit 3 to transmit the SNMP message to each one of the MFPs 61a to 61f.

At a2 of FIG. 10, the network device detector 4 of the management apparatus 50 causes the SNMP communication unit 3 to receive a SNMP response from each one of the MFPs 61a to 61f to collect address information of each one of the MFPs 61a to 61f. The SNMP response includes the IPv6 address information and the MAC address information of each device.

At a3 of FIG. 10, the network list generator of the management apparatus 50 generates a network device list, which lists the address information of the MFPs 61a to 61f.

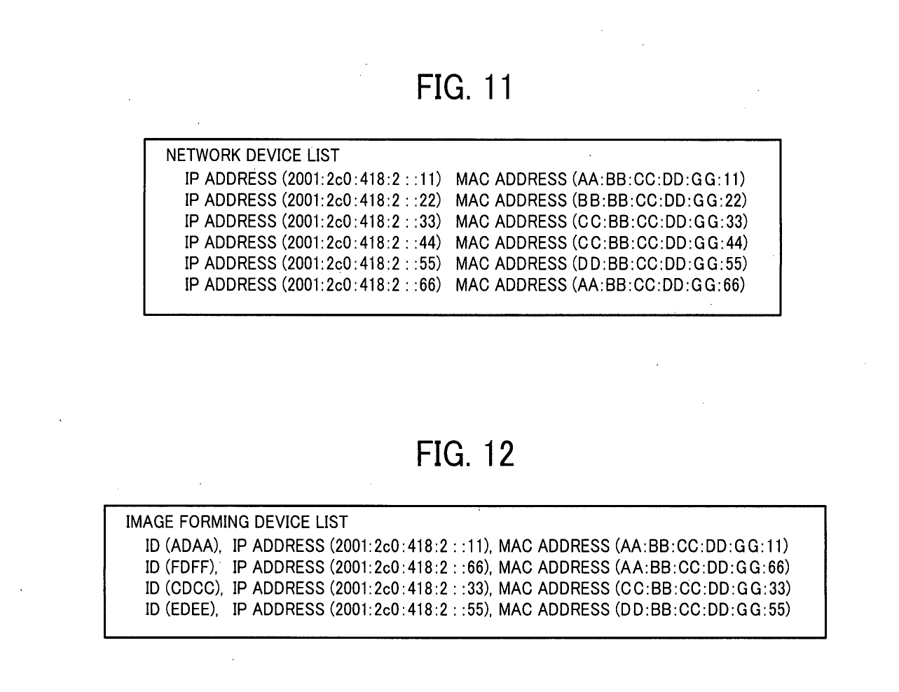

In this example, as illustrated in FIG. 11, the network device list includes the IP address “2001:2c0:418:2::11” and the MAC address “AA:BB:CC:DD:GG:11” of the MFP 61a, the IP address “2001:2c0:418:2::22” and the MAC address “BB:BB:CC:DD:GG:22” of the MFP 61b, the IP address “2001:2c0:418:2::33” and the MAC address “CC:BB:CC:DD:GG:33” of the MFP 61c, the IP address “2001:2c0:418:2::44” and the MAC address “CC:BB:CC:DD:GG:44” of the MFP 61d, the IP address “2001:2c0:418:2::55” and the MAC address “DD:BB:CC:DD:GG:55” of the MFP 61e, and the IP address “2001:2c0:418:2::66” and the MAC address “AA:BB:CC:DD:GG:66” of the MFP 61f.

At a4 of FIG. 10, the management apparatus 50 determines whether any one of the devices listed on the network device list is a device to be communicated, based on the filtering rule stored in the filtering rule storage 7. When there is more than one device to be communicated, the management apparatus 50 further determines a priority order in communicating each device based on the filtering rule stored in the filtering rule storage 7. More specifically, in this example, the management apparatus 50 determines whether any one of the MFPs 61a to 61f listed in the network device list of FIG. 11 needs to be communicated, and determines a priority order in communicating the MFPs 61a to 61f.

For example, assuming that the filtering rule of FIG. 5 is applied, the communication priority set 6 of the management apparatus 50 determines that the MFP 61a and the MFP 61f are to be communicated first, the MFP 61b to be not searched, the MFP 61c and MFP 61d to be communicated second, and the MFP 61e to be communicated third. The determination result is sent to the image forming device search and determination list generator 8. Based on this determination result, the image forming device search and determination list generator 8 may generate an image forming device determination list, which lists one or more devices to be communicated.

At a5 of FIG. 10, the image forming device search and determination list generator 8 requests each device that is determined to be communicated to send the identification information of an image forming device. More specifically, as illustrated below, the image forming device search and determination list generator 8 communicates with the MFP 61, by SOAP communication or HTTP communication through the SOAP/HTTP communication unit 9, or by SNMP communication by the SNMP communication unit 3, to obtain identification information of the MFP 61. Further, the image forming device search and determination list generator 8 communicates with the MFP 61 in the priority order determined at a4 based on the filtering rule.

At a6 of FIG. 10, the image forming device search and determination list generator 8 communicates with the MFP 61a and the MFP 61f, which are to be communicated first. The image forming device search and determination list generator 8 communicates with the MFP 61a to obtain identification information of the MFP 61a. For example, the “ID: ADAA” of the MFP 61a may be obtained. In a substantially similar manner, the image forming device search and determination list generator 8 communicates with the MFP 61f to obtain the identification information of the MFP 41f, such as the “ID: FDFF” of the MFP 61f.

At a7 of FIG. 10, the image forming device search and determination list generator 8 communicates with the MFP 61c, which is to be communicated second, to obtain identification information “ID: CDCC” of the MFP 61c. The image forming device search and determination list generator 8 communicates with the MFP 61d, which is to be communicate second. However, in this case, it is assumed that there is no response from the MFP 61d such that no identification information is obtained for the MFP 61d.

At a8 of FIG. 10, the image forming device search and determination list generator 8 communicates with the MFP 61e, which is to be communicated third, to obtain identification information “ID: EDEE” of the MFP 61e. The MFP 61b is not communicated as it is not to be searched.

At a9 of FIG. 10, the image forming device search and determination list generator 8 determines that one or more devices from which the identification information are successfully obtained, as an image forming device to be managed by the management apparatus 50. For example, as illustrated in FIG. 12, the image forming device search and determination list generator 8 generates an image forming device list, which, stores the identification information that is obtained from the MFP 61 at a5 in association with the address information of the MFP 61 obtained at a2 for the MFP 61a, 61b, 61c, 61e, and 61f. The image forming device list is stored in the image forming device list storage 10.

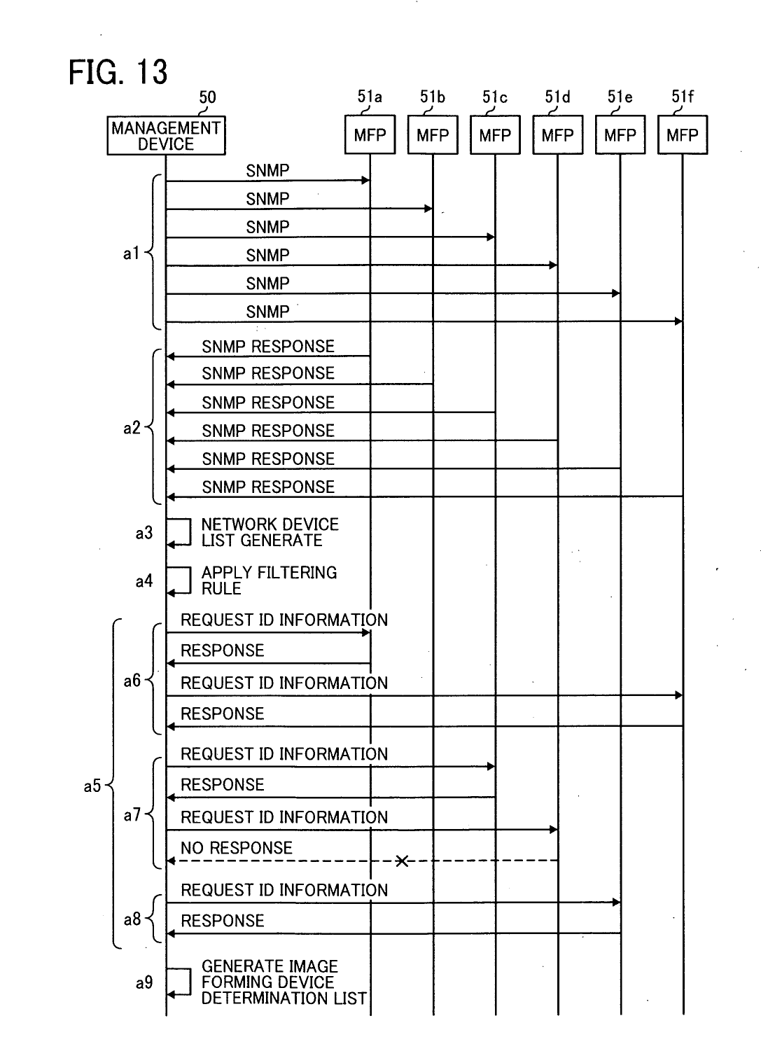

Referring now to FIGS. 1, 2, and 13 to 15, operation of generating an image forming device list, performed by the management apparatus 50 of the network system of FIG. 2, is explained according to an example embodiment of the present invention. FIG. 13 illustrates a data sequence diagram illustrating operation of generating an image forming device list of the devices on the network 22, performed by the management apparatus 50. The MFPs 51c, 51b, and 51e of FIG. 13 are not shown in FIG. 2. This example illustrates the case in which the image forming device list is generated for the network devices in the IPv4 network environment, in which the use of arp is prohibited.

At a1 and a2 of FIG. 13, the management apparatus 50 of FIG. 2 communicates with a plurality of devices on the network by multicast to obtain address information of each device on the network. For example, the IPv4 multicast address to be used for multicast may be designated to the management apparatus 50 through the operation unit 14 of the management apparatus 50 or through the center apparatus 27. Alternatively, the LAN 53 to which the management apparatus 50 is connected may be previously designated with the IPv4 multicast address. The network device detector 4 causes the SNMP communication unit 3 to transmit the SNMP message to each one of the devices each having the designated IPv6 multicast address by specifying the designated IPv4 multicast address as a destination address. In this example, at a1 of FIG. 13, the network device detector 4 causes the SNMP communication unit 3 to transmit the SNMP message to each one of the MFPs 51a to 51f.

At a2 of FIG. 13, the network device detector 4 of the management apparatus 50 causes the SNMP communication unit 3 to receive a SNMP response from each one of the MFPs 51a to 51f to collect address information of each one of the MFPs 51a to 51f. The SNMP response includes the IPv4 address information and the MAC address information of each device.

At a3 of FIG. 13, the network list generator of the management apparatus 50 generates a network device list, which lists the address information of the MFPs 51a to 51f.

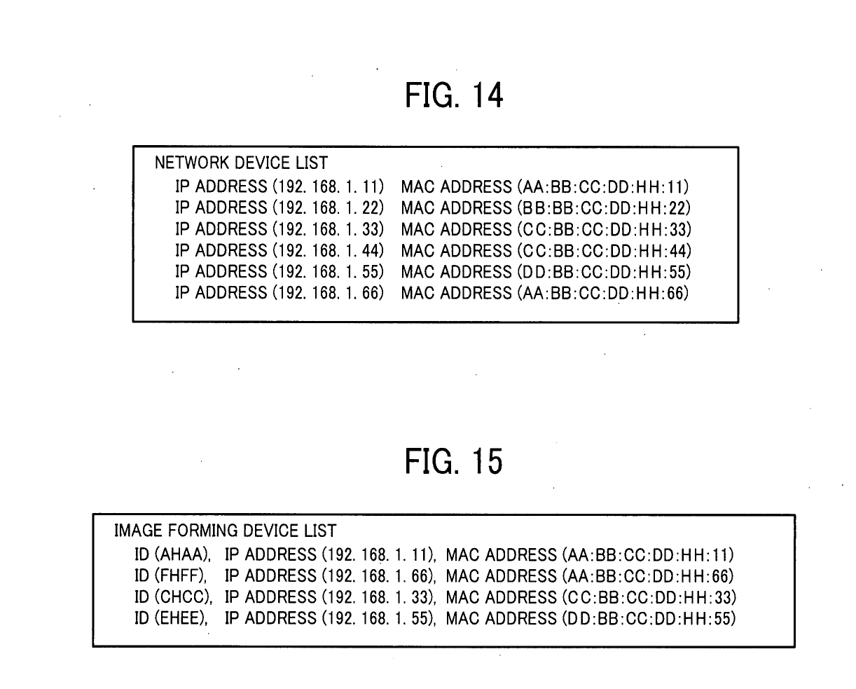

In this example, as illustrated in FIG. 14, the network device list includes the IP address “192.168.1.11” and the MAC address “AA:BB:CC:DD:HH:11” of the MFP 51a, the IP address “192.168.1.22” and the MAC address “BB:BB:CC:DD:HH:22” of the MFP 51b, the IP address “192.168.1.33” and the MAC address “CC:BB:CC:DD:HH:33” of the MFP 51c, the IP address “192.168.1.44” and the MAC address “CC:BB:CC:DD:HH:44” of the MFP 51d, the IP address “192.168.1.55” and the MAC address “DD:BB:CC:DD:HH:55” of the MFP 51e, and the IP address “192.168.1.66” and the MAC address “AA:BB:CC:DD:HH:66” of the MFP 51f.

At a4 of FIG. 13, the management apparatus 50 determines whether any one of the devices listed on the network device list is a device to be communicated, based on the filtering rule stored in the filtering rule storage 7. When there is more than one device to be communicated, the management apparatus 50 further determines a priority order in communicating each device based on the filtering rule stored in the filtering rule storage 7. More specifically, in this example, the management apparatus 50 determines whether any one of the MFPs 51a to 51f listed in the network device list of FIG. 14 needs to be communicated, and determines a priority order in communicating the MFPs 51a to 51f.

For example, assuming that the filtering rule of FIG. 5 is applied, the communication priority set 6 of the management apparatus 50 determines that the MFP 51a and the MFP 51f are to be communicated first, the MFP 51b to be not searched, the MFP 51c and MFP 51d to be communicated second, and the MFP 51e to be communicated third. The determination result is sent to the image forming device search and determination list generator 8. Based on this determination result, the image forming device search and determination list generator 8 may generate an image forming device determination list, which lists one or more devices to be communicated.

At a5 of FIG. 13, the image forming device search and determination list generator 8 requests each device that is determined to be communicated to send the identification information of the image forming device. More specifically, as illustrated below, the image forming device search and determination list generator 8 communicates with the MFP 51, by SOAP communication or HTTP communication through the SOAP/HTTP communication unit 9, or by SNMP communication by the SNMP communication unit 3, to obtain identification information of the MFP 51. Further, the image forming device search and determination list generator 8 communicates with the MFP 51 in the priority order determined at a4 based on the filtering rule.

At a6 of FIG. 13, the image forming device search and determination list generator 8 communicates with the MFP 51a, which is to be communicated first, to obtain identification information of the MFP 51a. For example, the “ID: AHAA” of the MFP 51a may be obtained. In a substantially similar manner, the image forming device search and determination list generator 8 communicates with the MFP 51f, which is to be communicated first, to obtain the identification information of the MFP 51f, such as the “ID: FHFF” of the MFP 51f.

At a7 of FIG. 13, the image forming device search and determination list generator 8 communicates with the MFP 51c, which is to be communicated second, to obtain identification information “ID: CHCC” of the MFP 51c. The image forming device search and determination list generator 8 communicates with the MFP 51d, which is to be communicated second. However, in this case, it is assumed that there is no response from the MFP 51d such that no identification information is obtained for the MFP 51d.

At a8 of FIG. 13, the image forming device search and determination list generator 8 communicates with the MFP 51e, which is to be communicated third, to obtain identification information “ID: EHEE” of the MFP 51e.

At a9 of FIG. 13, the image forming device search and determination list generator 8 determines that one or more devices from which the identification information are obtained, as an image forming device to be managed by the management apparatus 50. For example, as illustrated in FIG. 13, the image forming device search and determination list generator 8 generates an image forming device list, which stores the identification information that is obtained from the MFP 51 at a5 in association with the address information of the MFP 51 obtained at a2 for the MFP 51a, 51b, 51c, 51e, and 51f. The image forming device list is stored in the image forming device list storage 10.

As described above, any one of the apparatuses 30, 40, and 50 is able to generate an image forming device list, which lists one or more image forming devices to be managed, even in the IPv6 network environment or the IPv6 and IPv4 network environment.

When any one of the apparatuses 30, 40, and 50 receives an instruction, which selects any number of the MFPs (the selected MFP) that are listed in the image forming device list through the operation unit 14, the image forming device search and determination list generator 8 stores the address information of the selected MFP in the image forming device list storage 10, as an image forming device management list. The center device communication unit 12 sends the address information of the selected MFP, or the image forming device management list, to the center apparatus 27 through the network to cause the center apparatus 27 to store the address information of the selected MFP in its memory as the image forming device management list. In such case, any other information regarding the selected MFP may be stored as the image forming device management information in addition to or alternative to the address information of the selected MFP.

When the image forming device search and determination list generator 8 detects that communication between the management apparatus and one of the MFPs subjected for management is interrupted, the SNMP communication unit 3 and the SOAP/HTTP communication unit 9 obtain the MAC address of the MFP that is interrupted, and checks the location of the MFP on the network. The image forming device data change and communication unit 11 updates the address information of the MFP, which is stored in the image forming device list storage 10, with the address information obtained from the checked location. Alternatively or additionally, the image forming device data change and communication unit 11 may transmit the address information of the MFP, which is obtained from the checked location, to the center apparatus 27 through the center device communication unit 12. The center apparatus 27 updates the address information of the MFP, which is stored in its memory, with the obtained address information.

The image forming device data change and communication 11 transmits the address information of the device, which is determined to be the image forming device subjected for management by the management apparatus, to the center apparatus 27 through the center device communication unit 12.

The image forming device data change and communication unit 11 receives information from the center apparatus 27 through the center device communication unit 12, and sets settings information used for multicast communication with the network devices based on the settings information.

The center device communication unit 12 receives time information from the center apparatus 27, and sets a time at which the management apparatus generates or updates an image forming device list.

The filtering rule set 13 receives the filtering rule from the center apparatus 27 through the center device communication unit 12, and stores the filtering rule in the filtering rule storage 7.

As described above, the management apparatus obtains the MAC address of each network device on the IPv6 network by the ICMPv6 neighbor discovery to search one or more network devices each having the obtained MAC address, and determines whether any one of the searched network devices is an image forming device using a previously determined logic. Further, after one or more network devices each having the obtained MAC address are searched, a filtering rule, such as a MAC address prefix, may be applied to further limit a number of network devices subjected for further processing. With this technique, one or more image forming devices are searched with improved efficiency, even in the IPv6 environment or the IPv4 and IPv6 environment.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

For example, in order to determine whether the network device is an image forming device subjected for management, the management apparatus may determine whether the management apparatus receives any response from the network device in response to a HTTPS request addresses to the web service. Alternatively or additionally, the management apparatus may determine whether the identification information that is received from the network device indicates identification information of an image forming device. In this example, the identification information of the image forming device may be management information base (MIB) information that indicates that the device is an image forming device.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

In one example, the present invention may reside in: a management apparatus for managing an image forming device on a network. The management apparatus includes: address information collection means for communicating with a plurality of devices on a network by multicast to collect address information of each device on the network; means for generating a network device list that lists address information of each device on the network; means for communicating with one or more devices having its address information listed in the network device list to request identification information of an image forming device; means for determining that one or more devices from which the identification information of the image forming device are received is an image forming device to be managed; and means for generating an image forming device list that lists the address information of the device that is determined to be the image forming device.

The management apparatus further includes: rule information storage means for storing rule information, which is used to determine whether each one of the network devices having the address information listed in the network device list is subjected for further communication and to determine a priority order in communicating the network devices that are determined to be subjected for further communication; and communication determining means for determining whether each one of the network devices having the address information listed in the network device list is subjected for further communication and determining a priority order in communicating the network devices that are determined to be subjected for further communication using the rule information.

The address information collection means of the management apparatus includes means for obtaining the IPv6 multicast address designated to the management apparatus, transmitting the ICMPv6 message to each one of the plurality of devices each having the designated IPv6 multicast address, and collecting the address information of each one of the plurality of devices from the response received from each device in response to the ICMPv6 message, the address information including the IPv6 address information and the MAC address information of each device.

The address information collection means of the management apparatus includes means for obtaining the IPv6 multicast address designated to the network to which the management apparatus is connected, transmitting the ICMPv6 message to each one of the plurality of devices each having the designated IPv6 multicast address, and collecting the address information of each one of the plurality of devices from the response received from each device in response to the ICMPv6 message, the address information including the IPv6 address information and the MAC address information of each device.

The address information collection means of the management apparatus includes means for obtaining the IPv4 multicast address designated to the management apparatus, transmitting the arp message to each one of the plurality of devices each having the designated IPv4 multicast address, and collecting the address information of each one of the plurality of devices from the response received from each device in response to the arp message, the address information including the IPv4 address information and the MAC address information of each device.

The address information collection means of the management apparatus includes means for obtaining the IPv4 multicast address designated to the network to which the management apparatus is connected, transmitting the arp message to each one of the plurality of devices each having the designated IPv4 multicast address, and collecting the address information of each one of the plurality of devices from the response received from each device in response to the arp message, the address information including the IPv4 address information and the MAC address information of each device.

The management apparatus further includes registering means for obtaining a selected image forming device that is selected from the image forming device list; and registering the address information of the selected image forming device to at least one of the management apparatus and the center apparatus on the network.

The management apparatus further includes updating means for detecting interruption in communication between the management apparatus and the selected image forming device that is registered, checking a network location of the selected image forming device using the MAC address of the selected image forming device to generate a check result, and updating the address information of the selected image forming device stored in the management apparatus or the center apparatus with address information that reflects the check result.

The management apparatus further includes transmitting means for transmitting the address information of the image forming device to the center apparatus on the network.

The management apparatus further includes setting means for setting settings information used by the management apparatus for multicast communication with the plurality of devices on the network based on information received from the center apparatus on the network.

The management apparatus further includes time setting means for setting a time at which the image forming device list generating means generates the image forming device list, based on information received from the center apparatus on the network.

The management apparatus further includes means for storing the rule information received from the center apparatus on the network in the rule information storage means.

The address information collection means of the management apparatus includes means for determining whether the use of ICMPv6 is prohibited on the network; and when the use of ICMPv6 is prohibited, performing the following operations including: obtaining the IPv6 multicast address designated to the management apparatus or to the network to which the management apparatus is connected, transmitting the SNMP message to each one of the plurality of devices each having the designated IPv6 multicast address, and collecting the address information of each one of the plurality of devices from the response received from each device in response to the SNMP message, the address information including the IPv6 address information and the MAC address information of each device.

The address information collection means of the management apparatus includes means for determining whether the use of arp is prohibited on the network; and when the use of arp is prohibited, performing the following operations including: obtaining the IPv4 multicast address designated to the management apparatus or to the network to which the management apparatus is connected, transmitting the SNMP message to each one of the plurality of devices each having the designated IPv4 multicast address, and collecting the address information of each one of the plurality of devices from the response received from each device in response to the SNMP message, the address information including the IPv4 address information and the MAC address information of each device.

The identification information obtaining means of the management apparatus includes: means for obtaining the identification information of the image forming device by SOAP communication, HTTP communication, or SNMP communication.

In one example, the present invention may reside in an image forming device management system, which includes a plurality of devices including an image forming device, and a management apparatus connected to the plurality of devices through a network. The management apparatus includes: address information collecting means for communicating with the plurality of devices on the network by multicast to collect address information of the plurality of devices; network list generating means for generating a network device list, which lists the address information of the plurality of devices collected by the address information collection means; identification information obtaining means for communicating with one or more devices each having its address information listed in the network device list to request each device for identification information of the image forming device; and means for determining that one or more devices from which the identification information of the image forming device are obtained to be an image forming device to be managed by the management apparatus; and means for generating an image forming device list, which lists the address information of the one or more devices that are determined to be the image forming device to be managed. The network device including the image forming device includes means for sending the address information of the device in response to the multicast communication from the management apparatus. The image forming device includes means for sending the identification information of the image forming device in response to the communication from the management apparatus.

In one example, the present invention may reside in a method of managing an image forming device on a network, performed by a computer that causes a management apparatus to manage the image forming device on the network. The method includes: communicating with a plurality of devices on a network by multicast to obtain address information of the plurality of devices; generating a network device list, which lists the address information of the plurality of devices; communicating with one or more devices each having its address information listed in the network device list to request for identification information of an image forming device; determining that one or more devices from the identification information of the image forming device are received to be an image forming device to be managed by the management apparatus; and generating an image forming device list, which lists the address information of the one or more devices that are determined to be the image forming device to be managed.

In one example, the present invention may reside in a recording medium, which stores a plurality of instructions, which cause a processor to perform the above-described method.

With the above-described apparatus, system, method or program, one or more image forming devices subjected for management can be searched with improved efficiency, even in the IPv6 network environment.

What is claimed is:

1. A management apparatus, comprising:
a processor to:
communicate with a plurality of network devices on a network by specifying a multicast address to obtain address information of each one of the plurality of network devices;
generate a network device list, which lists the address information of the plurality of network devices;
communicate with one or more network devices each having the address information listed in the network device list to request each one of the one or more network devices for identification information of an image forming device;
determine that at least one network device from which the identification information of the image forming device is successfully obtained is an image forming device to be managed by the management apparatus; and
generate an image forming device list, which lists the address information of the at least one network device that is determined to be the image forming device to be managed by the management apparatus.

2. The management apparatus of claim 1, further comprising:
a storage device to store a filtering rule, wherein the processor is further configured to:
determine whether the plurality of network devices each having the address information listed in the network device list is subjected for further communication by the management apparatus, based on the filtering rule stored in the storage device, to specify the one or more network devices to be communicated to request for the identification information of the image forming device; and
determine a priority order in communicating with the one or more network devices to be communicated to request for the identification information of the image forming device, based on the filtering rule stored in the storage device.

3. The management apparatus of claim 2, wherein the processor is further configured to:
obtain an IPv6 multicast address designated to the management apparatus or to the network to which the management apparatus is connected;
transmit an ICMPv6 message to the plurality of network devices on the network by specifying the designated IPv6 multicast address as a destination address; and
obtain IPv6 address information and MAC address information of the plurality of network devices, respectively, from a plurality of responses received from the plurality of network devices in response to the ICMPv6 message.

4. The management apparatus of claim 2, wherein the processor is further configured to:
obtain an IPv4 multicast address designated to the management apparatus or to the network to which the management apparatus is connected;
transmit an arp message to the plurality of network devices on the network by specifying the designated IPv4 multicast address as a destination address; and
obtain IPv4 address information and MAC address information of the plurality of network devices, respectively, from a plurality of responses received from the plurality of network devices in response to the arp message.

5. The management apparatus of claim 3, wherein the processor is further configured to:
determine whether the use of ICMPv6 message is prohibited on the network; and
when the use of ICMPv6 message is prohibited, transmit a SNMP message to the plurality of network devices in alternative to transmitting the ICMPv6 message.

6. The management apparatus of claim 4, wherein the processor is further configured to:
determine whether the use of arp message is prohibited on the network; and
when the use of arp message is prohibited, transmit a SNMP message to the plurality of network devices in alternative to transmitting the arp message.

7. The management apparatus of claim 2, further comprising:
an input device to receive an instruction, which selects at least one of the image forming devices from the at least one network device listed in the image forming device list as a selected image forming device, wherein
the processor is further configured to register the address information of the selected image forming device in the storage device.

8. The management apparatus of claim 7, further comprising:
a communication device to send the address information of the selected image forming device to a center apparatus through the network to cause the center apparatus to register the address information of the selected image forming device in a memory.

9. The management apparatus of claim 8, wherein the processor is further configured to:
detect interruption in communication between the management apparatus and the selected image forming device that is registered;
check a location of the selected image forming device on the network using the registered address information of the selected image forming device to output a current network location of the selected image forming device; and
update the registered address information of the selected image forming device with address information that reflects the current network location of the selected image forming device.

10. The management apparatus of claim 8, wherein:
when the input device is further configured to receive an instruction from a user directly or through the center apparatus via the network, the processor is further configured to set settings information that is used for determining the multicast-based communication between the management apparatus and the network devices on the network based on the instruction.

11. The management apparatus of claim 10, wherein the settings information includes time information indicating a time at which the management apparatus generates or updates the image forming device list.

12. The management apparatus of claim 8, wherein:
when the input device is further configured to receive information regarding the filtering rule from a user directly or through the center apparatus via the network, the processor is further configured to set the filtering rule based on the received information.

13. The management apparatus of claim 2, further comprising:
a communication device to transmit a request to each one of the one or more network devices, which requests each one of the one or more network devices for identification information of an image forming device, in compliance with SOAP, HTTP, or SNMP.

14. A system for managing an image forming device on a network, the system comprising:
a plurality of network devices provided on the network and to include at least one image forming device;
a management apparatus connected to the plurality of network devices through the network, wherein the management apparatus includes:
means for communicating with a plurality of network devices on a network by specifying a multicast address to obtain address information of each one of the plurality of network devices;
means for generating a network device list, which lists the address information of the plurality of network devices;
means for communicating with one or more network devices each having the address information listed in the network device list to request each one of the one or more network devices for identification information of an image forming device;
means for determining that at least one network device from which the identification information of the image forming device is successfully obtained is an image forming device to be managed by the management apparatus; and
means for generating an image forming device list, which lists the address information of the at least one network device that is determined to be the image forming device to be managed by the management apparatus, and wherein each one of the plurality of the network devices includes:
means for transmitting the address information of the network device in response to a message addressed to the multicast address, and when one of the one or more network devices is an image forming device, the device further includes:
means for transmitting the identification information of the image forming device in response to a request received from the management apparatus.

15. The system of claim 14, further comprising:
a storage device to store a filtering rule, wherein management apparatus further includes:
means for determining whether the plurality of network devices each having the address information listed in the network device list is subjected for further communication by the management apparatus, based on the filtering rule stored in the storage device, to specify the one or more network devices to be communicated to request for the identification information of the image forming device; and
means for determining a priority order in communicating with the one or more network devices to be communicated to request for the identification information of the image forming device, based on the filtering rule stored in the storage device.

16. The system of claim 15, further comprising:
a center apparatus connected to the management apparatus, wherein the management apparatus further includes:
means for receiving an instruction, which selects at least one of the image forming devices from the at least one network device listed in the image forming device list as a selected image forming device;
means for registering the address information of the selected image forming device in the memory; and
means for sending the address information of the selected image forming device to the center apparatus through the network to cause the center apparatus, and wherein the center apparatus includes:
means for registering the address information of the selected image forming device in a memory.

17. A method of managing an image forming device using a management apparatus, the method comprising:
communicating with a plurality of network devices on a network by specifying a multicast address to obtain address information of each one of the plurality of network devices;
generating a network device list, which lists the address information of the plurality of network devices;
communicating with one or more network devices each having the address information listed in the network device list to request each one of the one or more network devices for identification information of an image forming device;
determining that at least one network device from which the identification information of the image forming device is successfully obtained is an image forming device to be managed by the management apparatus; and
generating an image forming device list, which lists the address information of the at least one network device that is determined to be the image forming device to be managed by the management apparatus.

18. The method of claim 17, further comprising:
storing, in a memory, a filter rule;
determining whether the plurality of network devices each having the address information listed in the network device list is subjected for further communication by the management apparatus, based on the filtering rule stored in the memory, to specify the one or more network devices to be communicated to request for the identification information of the image forming device; and
determining a priority order in communicating with the one or more network devices to be communicated to request for the identification information of the image forming device, based on the filtering rule stored in the memory.
